(19) United States
(12) Patent Application Publication
(10) Pub. No.: US 2026/0239505 A1
(43) Pub. Date: Aug. 13, 2026

(54) AUTOMATIC SWITCHING CIRCUIT WITH ENHANCED PHASE-CUT COMPATIBILITY

(71) Applicant: Zhuhai Demi Technology Co., Ltd., Zhuhai (CN)

(72) Inventors: Hongyu Cheng, Zhuhai (CN); Liutian Liang, Maoming (CN)

(21) Appl. No.: 19/637,341

(22) Filed: Apr. 2, 2026

(30) Foreign Application Priority Data
Mar. 20, 2026 (CN) 202610353121.7

(51) Int. Cl. H05B 45/31; H05B 45/10; H05B 45/345; H05B 45/59; H05B 47/25

(52) U.S. Cl. CPC H05B 45/31; H05B 45/10; H05B 45/345; H05B 45/59; H05B 47/25

(57) ABSTRACT

The present invention relates to the technical field of phase-cut control circuits, in particular to an automatic switching circuit with enhanced phase-cut compatibility, comprising a leading edge phase-cut/trailing edge phase-cut intelligent identification circuit, which internally includes an input interface circuit, a signal detection circuit, a holding current control circuit, a current-limiting protection circuit and a control chip U1, and further comprising a leading edge phase-cut/trailing edge phase-cut conversion circuit. Pin 7 of U1 is the output terminal NO-OFF of the leading edge phase-cut/trailing edge phase-cut intelligent identification circuit, used for algorithm identification and control of the leading edge phase-cut and trailing edge phase-cut conversion circuit.

### TECHNICAL FIELD

The present invention relates to the technical field of phase-cut control circuits, in particular to an automatic switching circuit with enhanced phase-cut compatibility.

### BACKGROUND ART

Phase-cut dimming technology is widely used in the field of diode LED dimming due to its advantages of low cost and simple circuit. The existing phase-cut dimming power supply technology has the following shortcomings:

Unstable holding current control: Traditional phase-cut holding current circuits have problems such as high power consumption, high heat generation, and uncontrollable holding current, which easily lead to oscillation and noise of the dimmer, and cannot adapt to the requirements of different phase-cut controllers.

Poor dimming compatibility: Although the existing phase-cut dimming technology can adjust the dimming curve, it does not perform cooperative control with the holding current circuit, resulting in insufficient holding current for some phase-cut controllers at the minimum/maximum conduction angle, leading to flicker and limited compatibility.

Flicker of low-power loads: Small-power diode LED lamps are prone to flicker during phase-cut dimming. The existing technology has problems of complex control, inflexibility and high cost.

Inability to identify leading edge phase-cut and trailing edge phase-cut: The existing technology only converts the phase-cut sine wave into a square wave through diodes and transistors and transmits it to the subsequent stage, and cannot identify leading edge phase-cut or trailing edge phase-cut. However, leading edge phase-cut and trailing edge phase-cut require different freewheeling currents, and the maximum and minimum conduction angles of leading edge phase-cut and trailing edge phase-cut are inconsistent. The inability to identify leading edge phase-cut and trailing edge phase-cut limits the compatibility of phase-cut dimming power supplies.

Poor dimming effect: Grid fluctuations lead to inaccurate phase-cut angle control. Limited by the current provided by the freewheeling circuit, the phase-cut waveform appears disordered when the phase-cut dimmer is dimming. Traditional zero-crossing detection circuits directly convert such disordered waveforms into square waves and transmit them to the subsequent stage circuit, resulting in poor dimming effect of the subsequent stage circuit.

Therefore, it is urgent to improve the phase-cut control circuit to solve the above problems.

### SUMMARY OF THE INVENTION

The purpose of the present invention is to provide an automatic switching circuit with enhanced phase-cut compatibility. Through multi-mode adaptive algorithm, intelligent detection and compensation, cooperative control and dynamic holding current regulation, it can maintain stable current compensation when controlled by different brands and models of dimmers, improve dimming compatibility, eliminate flicker of low-power loads, realize algorithm identification and control of leading edge phase-cut and trailing edge phase-cut conversion, improve dimming precision, and feature simple circuit and low cost.

To achieve the above purpose, the main technical solution adopted by the present invention includes:

The automatic switching circuit with enhanced phase-cut compatibility, comprising a leading edge phase-cut/trailing edge phase-cut intelligent identification circuit, which internally includes an input interface circuit, a signal detection circuit, a holding current control circuit, a current-limiting protection circuit and a control chip U1, and further comprising a leading edge phase-cut/trailing edge phase-cut conversion circuit;

The input interface circuit comprises a diode D1 and a diode D3, the anode of diode D1 is electrically connected to terminal L, the anode of diode D3 is electrically connected to terminal N, and the cathodes of diode D1 and diode D3 are commonly connected to an internal high-potential node of the circuit;

The signal detection circuit comprises a resistor R1, a resistor R2, a capacitor C1, a resistor R5, a diode D2 and a Zener diode Z1; one end of resistor R1 is electrically connected to the high-potential node, and the other end is electrically connected to one end of resistor R2; the other end of resistor R2 is electrically connected to the anode of diode D2, and the anode of diode D2 is electrically connected to the cathode of Zener diode Z1, one end of capacitor C1, pin 1 of control chip U1 and one end of resistor R5; the anode of Zener diode Z1, the other end of resistor R5, the other end of capacitor C1 and pin 2 of control chip U1 are grounded;

The holding current control circuit comprises a transistor Q1, a diode D4, a resistor R3, a resistor R4, a resistor R7 and a resistor R8; the collector of transistor Q1 is electrically connected to one end of resistor R4; the other end of resistor R4 is electrically connected to the output terminal of the signal input interface; the emitter of transistor Q1 is electrically connected to one end of resistor R8 through resistor R7; the other end of resistor R8 is electrically connected to ground; one end of resistor R3 is electrically connected to pin 3 of control chip U1, one end of resistor R6 and Zener diode Z2, and the other end of resistor R3 is electrically connected to the output terminal of the signal input interface; the other end of Zener diode Z2 is grounded; the other end of resistor R6 is electrically connected to the anode of diode D4 and the collector of transistor Q2; the cathode of diode D4 is electrically connected to the base of transistor Q1; under the control of pin 3 of control chip U1, transistor Q1 conducts current from the input interface circuit through resistor R4, transistor Q1, resistor R7 and resistor R8 to ground, and this current flows through the phase-cut dimmer in the external main circuit as a holding current to prevent its false turn-off;

The current-limiting protection circuit comprises a transistor Q2, a resistor R7 and a resistor R8; one end of resistor R7 is electrically connected to the emitter of transistor Q1 and the base of transistor Q2, the other end is electrically connected to one end of resistor R8, and the other end of resistor R8 is grounded; when the current flowing through resistor R7 and resistor R8 exceeds a set threshold, the voltage drop generated at the other end connected to resistor R7 and resistor R8 triggers transistor Q2 to conduct, and after transistor Q2 conducts, it pulls down the base voltage of transistor Q1, keeping the flowing current at the set value to realize current-limiting protection;

Pin 4 of control chip U1 is electrically connected to capacitor C2, the other end of capacitor C2 is grounded, pin 7 of control chip U1 is the output terminal NO-OFF of the leading edge phase-cut/trailing edge phase-cut intelligent identification circuit, used for algorithm identification and control of the leading edge phase-cut and trailing edge phase-cut conversion circuit;

The leading edge phase-cut/trailing edge phase-cut conversion circuit comprises a capacitor C3, a resistor R9, a resistor R10, a resistor R11, a resistor R12, an optocoupler triac U2 and a field-effect transistor Q3. The input terminal ACL is electrically connected to fuse F1 and then to capacitor C3, the other end of capacitor C3 is electrically connected to resistor R9, the other end of resistor R9 is electrically connected to pin 4 of optocoupler triac U2, pin 3 of optocoupler triac U2 is electrically connected to input terminal ACN, pin 1 of optocoupler triac U2 is electrically connected to resistor R10, the other end of resistor R10 is connected to power supply VCC, pin 2 of optocoupler triac U2 is electrically connected to the D pole of field-effect transistor Q3, resistor R11 is electrically connected to the G pole of field-effect transistor Q3 and resistor R12, the other end of resistor R12 and the S pole of field-effect transistor Q3 are connected to ground, and one end of resistor R11 is electrically connected to the output terminal NO-OFF of the leading edge phase-cut/trailing edge phase-cut intelligent identification circuit.

The present invention has at least the following beneficial effects:

Through multi-mode adaptive algorithm, intelligent detection and compensation, cooperative control and dynamic holding current regulation, it can maintain stable current compensation when controlled by different brands and models of dimmers, improve dimming compatibility, eliminate flicker of low-power loads, realize adaptive leading edge phase-cut and trailing edge phase-cut conversion, improve dimming precision, and feature simple circuit and low cost.

### BRIEF DESCRIPTION OF THE DRAWINGS

The drawings described herein are used to provide a further understanding of the present application and constitute a part of the present application. The schematic embodiments of the present application and their descriptions are used to explain the present application and do not constitute an improper limitation of the present application. In the drawings:

FIG. 1 is a circuit diagram of the present invention;

FIG. 2 is a circuit structure diagram of the present invention.

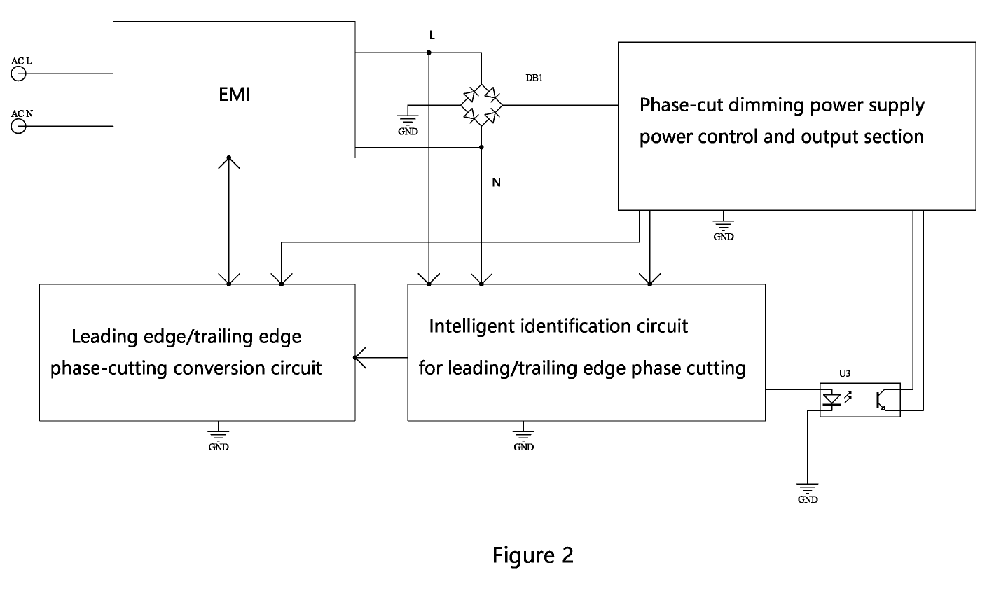

### DETAILED DESCRIPTION OF THE EMBODIMENTS

The embodiments of the present application will be described in detail below with reference to the drawings and examples, so as to fully understand how the present application applies technical means to solve technical problems and achieve technical effects.

### Embodiment 1

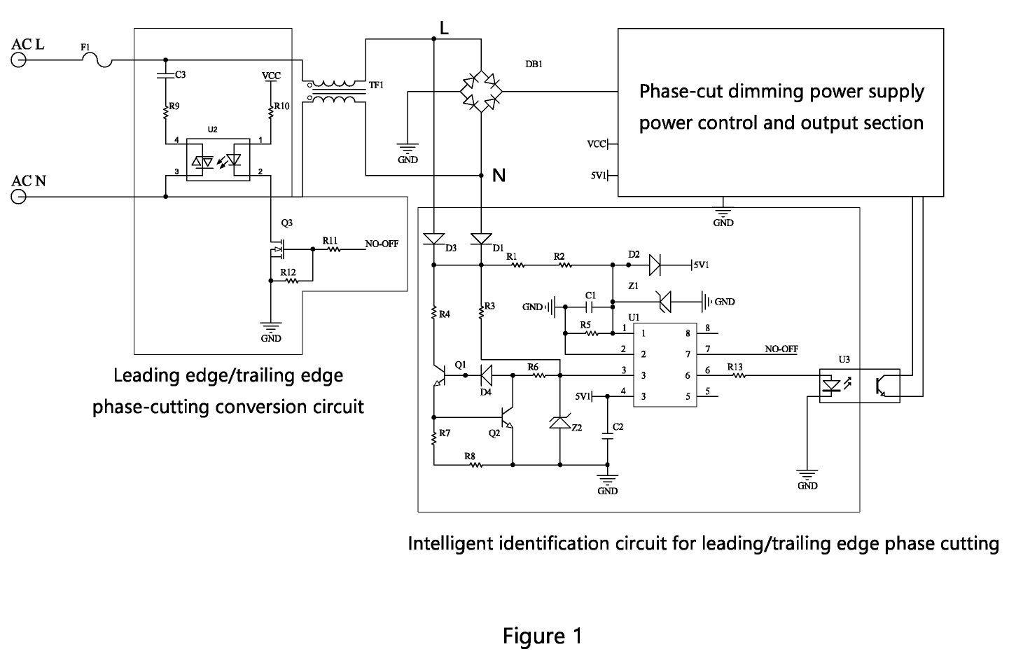

As shown in FIG. 1, the automatic switching circuit with enhanced phase-cut compatibility provided in this embodiment has its input terminals AC L and AC N connected to the AC voltage after phase-cut by the phase-cut dimmer, comprising a leading edge phase-cut/trailing edge phase-cut intelligent identification circuit, which internally includes an input interface circuit, a signal detection circuit, a holding current control circuit, a current-limiting protection circuit and a control chip U1, and further comprising a leading edge phase-cut/trailing edge phase-cut conversion circuit;

The input interface circuit comprises a diode D1 and a diode D3, the anode of diode D1 is electrically connected to terminal L, the anode of diode D3 is electrically connected to terminal N, and the cathodes of diode D1 and diode D3 are commonly connected to an internal high-potential node of the circuit; this input interface circuit is used to convert the phase-cut AC signal output by the phase-cut dimmer into a phase-cut half-wave and introduce it into the circuit, serving as the input for signal detection and holding current loop.

The signal detection circuit comprises a resistor R1, a resistor R2, a capacitor C1, a resistor R5, a diode D2 and a Zener diode Z1; one end of resistor R1 is electrically connected to the high-potential node (i.e., the connection point of cathodes of D1 and D3), and the other end is electrically connected to one end of resistor R2; the other end of resistor R2 is electrically connected to the anode of diode D2, and the anode of diode D2 is electrically connected to the cathode of Zener diode Z1, one end of capacitor C1, pin 1 of control chip U1 and one end of resistor R5; the anode of Zener diode Z1, the other end of resistor R5, the other end of capacitor C1 and pin 2 of control chip U1 are grounded (GND);

The function of this circuit is to collect the phase-cut half-wave signal output by the input interface circuit and input the signal to the control chip U1. The control chip U1 can sample data through one of the following methods: ADC, IO high and low level, internal comparator, analog watchdog, fuse data through algorithm to realize waveform restoration, extract waveform features through algorithm, analyze the conduction angle information (dimming brightness) and leading/trailing edge information of the current phase-cut dimmer, and generate control data for the holding current circuit to control the holding current circuit.

The holding current control circuit comprises a transistor Q1, a diode D4, a resistor R3, a resistor R4, a resistor R7 and a resistor R8; the collector of transistor Q1 is electrically connected to one end of resistor R4; the other end of resistor R4 is electrically connected to the output terminal of the signal input interface (i.e., the connection point of cathodes of D1 and D3); the emitter of transistor Q1 is electrically connected to one end of resistor R8 through resistor R7; the other end of resistor R8 is electrically connected to ground (GND); one end of resistor R3 is electrically connected to pin 3 of control chip U1, one end of resistor R6 and Zener diode Z2, and the other end of resistor R3 is electrically connected to the output terminal of the signal input interface (i.e., the connection point of cathodes of D1 and D3); the other end of Zener diode Z2 is grounded (GND); the other end of resistor R6 is electrically connected to the anode of diode D4 and the collector of transistor Q2; the cathode of diode D4 is electrically connected to the base of transistor Q1; under the control of pin 3 of control chip U1, transistor Q1 conducts current from the input interface circuit through resistor R4, transistor Q1, resistor R7 and resistor R8 to ground, and this current flows through the phase-cut dimmer in the external main circuit as a holding current to prevent its false turn-off;

The current-limiting protection circuit comprises a transistor Q2, a resistor R7 and a resistor R8; one end of resistor R7 is electrically connected to the emitter of transistor Q1 and the base of transistor Q2, the other end is electrically connected to one end of resistor R8, and the other end of resistor R8 is grounded (GND); when the current flowing through resistor R7 and resistor R8 exceeds a set threshold, the voltage drop generated at the other end connected to resistor R7 and resistor R8 triggers transistor Q2 to conduct, and after transistor Q2 conducts, it pulls down the base voltage of transistor Q1, keeping the flowing current at the set value to realize current-limiting protection;

Pin 4 of control chip U1 is electrically connected to capacitor C2, the other end of capacitor C2 is grounded, pin 7 of control chip U1 is the output terminal NO-OFF of the leading edge phase-cut/trailing edge phase-cut intelligent identification circuit, used for algorithm identification and control of the leading edge phase-cut and trailing edge phase-cut conversion circuit. Capacitor C2 serves as a power supply bypass filter capacitor for control chip U1. Control chip U1 is used to receive input from the signal detection circuit, output control signals to the holding current control circuit and output phase-cut phase calculated by the algorithm. The final phase output can be selected from one of the following signals: PWM signal, serial port signal, or other digital coding signals such as Manchester code to pin 6 (OUT) of control chip U1. The power supply of control chip U1 is provided by an external circuit.

The leading edge phase-cut/trailing edge phase-cut conversion circuit comprises a capacitor C3, a resistor R9, a resistor R10, a resistor R11, a resistor R12, an optocoupler triac U2 and a field-effect transistor Q3. The input terminal ACL is electrically connected to fuse F1 and then to capacitor C3, the other end of capacitor C3 is electrically connected to resistor R9, the other end of resistor R9 is electrically connected to pin 4 of optocoupler triac U2, pin 3 of optocoupler triac U2 is electrically connected to input terminal ACN, pin 1 of optocoupler triac U2 is electrically connected to resistor R10, the other end of resistor R10 is connected to power supply VCC, pin 2 of optocoupler triac U2 is electrically connected to the D pole of field-effect transistor Q3, resistor R11 is electrically connected to the G pole of field-effect transistor Q3 and resistor R12, the other end of resistor R12 and the S pole of field-effect transistor Q3 are connected to ground, and one end of resistor R11 is electrically connected to the output terminal NO-OFF of the leading edge phase-cut/trailing edge phase-cut intelligent identification circuit.

The working principle of the multifunctional novel phase-cut control circuit provided in this embodiment is as follows:

When an external phase-cut dimmer is connected, phase-cut voltage appears at input terminals ACL and ACN. Pin 1 of control chip U1 passes through the signal detection circuit composed of diode D1, diode D3 and subsequent resistor R1, resistor R2, diode D2, Zener diode Z1, capacitor C1 and resistor R5. According to the waveform characteristics of the signal, control chip U1 analyzes the conduction angle information (dimming brightness) and leading/trailing edge information of the current phase-cut dimmer through algorithm operation, and calculates the holding current control data.

According to the calculated conduction angle information (dimming brightness), holding current control data and leading/trailing edge information of the phase-cut dimmer, the holding current control circuit is dynamically controlled on demand. Pin 3 of control chip U1 outputs a high-level driving signal, which passes through resistor R6 and diode D4 to the base of transistor Q1, turning on transistor Q1. After transistor Q1 is turned on, current flows from the phase-cut AC voltage (L, N) output by the phase-cut dimmer through (diode D1, diode D3), resistor R4, transistor Q1, resistor R7 and resistor R8 to ground (GND). This current flows through the phase-cut dimmer in the external main circuit to ensure that the total current is not lower than the holding current and prevent the dimmer from false turn-off;

During normal operation, when the voltage drop across resistor R7 and resistor R8 reaches the conduction threshold of transistor Q2, transistor Q2 is in an amplified state, pulling down the base potential of transistor Q1, forcing the current flowing through transistor Q1 to decrease, realizing fast overcurrent protection, and effectively solving the compatibility and reliability problems in phase-cut dimming.

The leading edge phase-cut/trailing edge phase-cut intelligent identification circuit analyzes and confirms whether a phase-cut dimmer is currently connected through algorithm according to the signal provided by the signal detection circuit connected to pin 1 of control chip U1, and identifies whether the connected dimmer type is leading edge phase-cut or trailing edge phase-cut. Pin 7 of control chip U1 outputs high level for leading edge phase-cut. Pin 7 of control chip U1 outputs low level for trailing edge phase-cut.

In the leading edge phase-cut/trailing edge phase-cut conversion circuit, one end of resistor R11 receives the control signal from pin 7 of control chip U1. When the signal is high level, field-effect transistor Q3 is turned on, pins 4 and 3 of optocoupler triac U2 are turned on, and the RC absorption circuit composed of capacitor C3 and resistor R9 is turned on to absorb the voltage spike generated during chopping of the leading edge phase-cut dimmer, enabling good conduction of the leading edge phase-cut dimmer. When one end of resistor R11 receives a low level from pin 7 of control chip U1, field-effect transistor Q3 is turned off, pins 4 and 3 of optocoupler triac U2 are disconnected, the RC absorption circuit composed of capacitor C3 and resistor R9 is not turned on, and the waveform generated during chopping of the trailing edge phase-cut dimmer will not be deformed, enabling good conduction of the trailing edge dimmer.

### Embodiment 2:

This embodiment provides an implementation method based on the multifunctional novel phase-cut control circuit in Embodiment 1, including the following steps:

Signal collection and processing: The phase-cut AC voltage (L, N) output by the phase-cut dimmer is introduced through diode D1 and diode D3, divided by resistor R1, resistor R2 and resistor R5, and then input to pin 1 of control chip U1, where capacitor C1 is for filtering, diode D2 is for voltage clamping, and Zener diode Z1 is for voltage regulation; through voltage clamping by diode D2, voltage regulation by Zener diode Z1 and filtering by capacitor C1, the final detection signal is input to pin 1 of control chip U1. According to the waveform characteristics of the signal, control chip U1 fuses data through algorithm to realize waveform restoration, extracts waveform features through algorithm, analyzes the conduction angle information (dimming brightness) and leading/trailing edge information of the current phase-cut dimmer, and generates control data for the holding current circuit to control the holding current circuit.

Dynamic regulation of holding current: Control chip U1 automatically and dynamically regulates the holding current by controlling transistor Q1 through pin 3 according to the analyzed conduction angle information (dimming brightness), holding current control data, leading/trailing edge information and load status of the current phase-cut dimmer, so as to ensure that the external phase-cut dimmer is not falsely turned off or poorly conducted; the specific implementation is: pin 3 of control chip U1 outputs a high-level driving signal, which passes through resistor R6 and diode D4 to the base of transistor Q1, turning on transistor Q1; after transistor Q1 is turned on, current flows from the phase-cut AC voltage (L, N) output by the phase-cut dimmer through diode D1, diode D3, resistor R4, transistor Q1, resistor R7 and resistor R8 to ground. This current flows through the phase-cut dimmer in the external main circuit to ensure that the total current is not lower than the holding current and prevent the dimmer from false turn-off. At the same time, pin 6 of control chip U1 outputs the phase-cut phase calculated by the algorithm, and the final phase output can be selected from one of the following signals: PWM signal, serial port signal, or other digital coding signals such as Manchester code;

Overcurrent protection action: During the conduction of transistor Q1, current flows through detection resistors R7 and R8; during normal operation, the voltage drop across resistor R7 and resistor R8 is close to the conduction threshold of transistor Q2, and the current in transistor Q2 and transistor Q1 is in a balanced state. If a circuit fault causes the current of transistor Q1 to increase abnormally, the voltage drop across resistor R7 and resistor R8 exceeds the conduction threshold of transistor Q2; at this time, transistor Q2 is quickly turned on, pulling the base potential of transistor Q1 down to ground potential, forcing transistor Q1 to cut off, cutting off the holding current loop, and protecting circuit components.

The present invention has at least the following beneficial effects: Through multi-mode adaptive algorithm, intelligent detection and compensation, cooperative control and dynamic holding current regulation, it can maintain stable current compensation when controlled by different brands and models of dimmers, improve dimming compatibility, eliminate flicker of low-power loads, realize adaptive leading edge phase-cut and trailing edge phase-cut, improve dimming precision, and feature simple circuit and low cost.

The above descriptions are only preferred embodiments of the present invention, and are not intended to limit the present invention in any form. Although the present invention has been disclosed as preferred embodiments, it is not intended to limit the present invention. Any person skilled in the art, without departing from the scope of the technical solution of the present invention, may make a few changes or modifications to the equivalent embodiments equivalent to the above disclosed technical content, but all simple modifications, equivalent changes and modifications to the above embodiments according to the technical essence of the present invention still fall within the scope of the technical solution of the present invention.

1. An automatic switching circuit with enhanced phase-cut compatibility, characterized by comprising a leading edge phase-cut/trailing edge phase-cut intelligent identification circuit, which internally includes an input interface circuit, a signal detection circuit, a holding current control circuit, a current-limiting protection circuit and a control chip U1, and further comprising a leading edge phase-cut/trailing edge phase-cut conversion circuit;
The input interface circuit comprises a diode D1 and a diode D3, the anode of diode D1 is electrically connected to terminal L, the anode of diode D3 is electrically connected to terminal N, and the cathodes of diode D1 and diode D3 are commonly connected to an internal high-potential node of the circuit;
The signal detection circuit comprises a resistor R1, a resistor R2, a capacitor C1, a resistor R5, a diode D2 and a Zener diode Z1; one end of resistor R1 is electrically connected to the high-potential node, and the other end is electrically connected to one end of resistor R2; the other end of resistor R2 is electrically connected to the anode of diode D2, and the anode of diode D2 is electrically connected to the cathode of Zener diode Z1, one end of capacitor C1, pin 1 of control chip U1 and one end of resistor R5; the anode of Zener diode Z1, the other end of resistor R5, the other end of capacitor C1 and pin 2 of control chip U1 are grounded;
The holding current control circuit comprises a transistor Q1, a diode D4, a resistor R3, a resistor R4, a resistor R7 and a resistor R8; the collector of transistor Q1 is electrically connected to one end of resistor R4; the other end of resistor R4 is electrically connected to the output terminal of the signal input interface; the emitter of transistor Q1 is electrically connected to one end of resistor R8 through resistor R7; the other end of resistor R8 is electrically connected to ground; one end of resistor R3 is electrically connected to pin 3 of control chip U1, one end of resistor R6 and Zener diode Z2, and the other end of resistor R3 is electrically connected to the output terminal of the signal input interface; the other end of Zener diode Z2 is grounded; the other end of resistor R6 is electrically connected to the anode of diode D4 and the collector of transistor Q2; the cathode of diode D4 is electrically connected to the base of transistor Q1; under the control of pin 3 of control chip U1, transistor Q1 conducts current from the input interface circuit through resistor R4, transistor Q1, resistor R7 and resistor R8 to ground, and this current flows through the phase-cut dimmer in the external main circuit as a holding current to prevent its false turn-off;
The current-limiting protection circuit comprises a transistor Q2, a resistor R7 and a resistor R8; one end of resistor R7 is electrically connected to the emitter of transistor Q1 and the base of transistor Q2, the other end is electrically connected to one end of resistor R8, and the other end of resistor R8 is grounded; when the current flowing through resistor R7 and resistor R8 exceeds a set threshold, the voltage drop generated at the other end connected to resistor R7 and resistor R8 triggers transistor Q2 to conduct, and after transistor Q2 conducts, it pulls down the base voltage of transistor Q1, keeping the flowing current at the set value to realize current-limiting protection;
Pin 4 of control chip U1 is electrically connected to capacitor C2, the other end of capacitor C2 is grounded, pin 7 of control chip U1 is the output terminal NO-OFF of the leading edge phase-cut/trailing edge phase-cut intelligent identification circuit, used for algorithm identification and control of the leading edge phase-cut and trailing edge phase-cut conversion circuit;
The leading edge phase-cut/trailing edge phase-cut conversion circuit comprises a capacitor C3, a resistor R9, a resistor R10, a resistor R11, a resistor R12, an optocoupler triac U2 and a field-effect transistor Q3. The input terminal ACL is electrically connected to fuse F1 and then to capacitor C3, the other end of capacitor C3 is electrically connected to resistor R9, the other end of resistor R9 is electrically connected to pin 4 of optocoupler triac U2, pin 3 of optocoupler triac U2 is electrically connected to input terminal ACN, pin 1 of optocoupler triac U2 is electrically connected to resistor R10, the other end of resistor R10 is connected to power supply VCC, pin 2 of optocoupler triac U2 is electrically connected to the D pole of field-effect transistor Q3, resistor R11 is electrically connected to the G pole of field-effect transistor Q3 and resistor R12, the other end of resistor R12 and the S pole of field-effect transistor Q3 are connected to ground, and one end of resistor R11 is electrically connected to the output terminal NO-OFF of the leading edge phase-cut/trailing edge phase-cut intelligent identification circuit.
